(19) United States
(12) Patent Application Publication
(10) Pub. No.: US 2017/0047065 A1
(43) Pub. Date: Feb. 16, 2017

(54) VOICE-CONTROLLABLE IMAGE DISPLAY DEVICE AND VOICE CONTROL METHOD FOR IMAGE DISPLAY DEVICE

(71) Applicant: Nam Tae PARK, Daejeon (KR)

(72) Inventor: Nam Tae PARK, Daejeon (KR)

(21) Appl. No.: 15/306,487

(22) PCT Filed: Nov. 20, 2014
(86) PCT No.: PCT/KR2014/011197

§ 371 Date: Oct. 24, 2016

(30) Foreign Application Priority Data
May 13, 2014 (KR) 10-2014-0056992

(51) Int. Cl. G10L 15/22; G10L 17/22; G10L 17/06; G06F 3/0481

(52) U.S. Cl. CPC G10L 15/22; G06F 3/0481; G10L 17/22; G10L 17/06; G10L 2015/223

(57) ABSTRACT

A voice-controllable image display device comprises: a memory unit for storing therein a database to which identified voice data is allocated and mapped for each execution unit area of a screen displayed through the display unit; a voice recognition unit for receiving an input of a user's voice; an information processing unit for searching the database and determining whether there is identified voice data corresponding to the user's voice when the voice recognition unit receives the user's voice; and a control unit for generating an input signal in the execution unit area to which the identified voice data is allocated if there is identified voice data corresponding to the user's voice as a result of the determination by the information processing unit.

### CROSS-REFERENCE TO PRIO PATENT APPLICATIONS

This application is a National Stage Application of PCT International Application No. PCT/KR2014/011197 filed on Nov. 20, 2014, which claims priority to Korean Patent Application No. KR 10-2014-0056992 filed on May 13, 2014, which are all hereby incorporated by reference in their entirety.

### BACKGROUND

The present invention relates to a voice-controllable image display device and a voice control method for an image display device, and more particularly, to a voice-controllable image display device configured to compare a user's input voice with voice identification data allocated to each execution unit area on a screen displayed through a display unit and, when voice identification data corresponding to the user's voice is present, generate an input signal in an execution unit area to which the voice identification data is allocated and a voice control method for such an image display device.

In recent years, as various smart devices are released, image display devices are becoming multi-functional and improved, and also various input methods for controlling the image display devices are being developed. Input means such as a motion sensing remote controller, a touch screen, etc. are developed and provided in addition to conventional means such as a mouse, a keyboard, a touchpad, a button-type remote controller, etc. Among the various input means, a voice control method that recognizes a user's voice to control an image display device in order for the user to more easily control the image display device is getting a spotlight.

However, for a voice control method that recognizes a voice uttered by a user to control an image display device, a decrease in recognition rate due to oral structure and pronunciation differences in users and a user inconvenience of having to learn voice commands stored in a database have been pointed out as problems. That is, a voice control method that is satisfactory in terms of usability has not been implemented yet.

### SUMMARY

The present invention is intended to provide a voice-controllable image display device configured to compare a user's input voice with voice identification data allocated to each execution unit area on a screen displayed through a display unit and, when voice identification data corresponding to the user's voice is present, generate an input signal in an execution unit area to which the voice identification data is allocated to apply, to the voice control, convenience and intuitiveness of user experience (UX) of the existing touch screen control methods, and a voice control method for such an image display device.

In order to solve the above problem, the present invention provides a voice-controllable image display device having a display unit, the voice-controllable image display device including a memory unit configured to store a database in which voice identification data is allocated and mapped to each execution unit area on a screen displayed through the display unit; a voice recognition unit configured to receive a user's voice as an input; an information processing unit configured to search the database and determine whether voice identification data corresponding to the user's voice is present when the voice recognition unit receives the user's voice; and a control unit configured to generate an input signal in an execution unit area to which the voice identification data is allocated when the information processing unit determines that the voice identification data corresponding to the user's voice is present.

In this case, the display unit may be configured to show voice identification data allocated to each execution unit area on the screen when displaying the screen.

Also, in the database, the voice identification data may be allocated and mapped to each execution unit area on each of two different screens displayed through the display unit.

Also, the database may additionally store voice control data corresponding to a control command for performing a specific screen control based on the execution unit area to which the voice identification data is allocated, when the voice control data is used in combination with the voice identification data; when the voice recognition unit receives a user's voice, the information processing unit may search the database and determine whether voice identification data and voice control data corresponding to the user's voice are present; and when the information processing unit determines that the voice identification data and voice control data corresponding to the user's voice are present, the control unit may generate an input signal in an execution unit area to which the voice identification data is allocated and execute a control command corresponding to the voice control data based on the execution unit area for which the input signal is generated.

The present invention also provides a voice control method for an image display device performed in the voice-controllable image display device, the voice control method including steps of: (a) storing a database in which voice identification data is allocated and mapped to each execution unit area on a screen displayed through the display unit, by a memory unit; (b) receiving a user's voice as an input, by a voice recognition unit; (c) searching the database and determining whether voice identification data corresponding to the user's voice is present, by an information processing unit; and (d) generating an input signal in an execution unit area to which the voice identification data is allocated when the information processing unit determines that the voice identification data corresponding to the user's voice is present, by a control unit.

In this case, step (b) may be performed while voice data allocated to each execution unit area on the screen displayed through the display unit is shown.

Step (a) may be performed by storing the database additionally including voice control data corresponding to a control command for performing a specific screen control based on the execution unit area to which the voice identification data is allocated when the voice control data is used in combination with the voice identification data, by the memory unit; step (c) may be performed by searching the database and determining whether voice identification data and voice control data corresponding to the user's voice are present, by the information processing unit; and step (d) may be performed by generating an input signal in an execution unit area to which the voice identification data is allocated and executing a control command corresponding to the voice control data based on the execution unit area for which the input signal is generated when the information processing unit determines that the voice identification data and voice control data corresponding to the user's voice are present, by the control unit.

The voice-controllable image display device and the voice control method for the image display device according to the present invention have the following effects.

1. It is possible to implement a simple and accurate voice control by performing an input control through comparisons between a user's voice input and voice data allocated to each execution unit area on the screen displayed through the display unit and applying an input control method of the existing touch screen type without any change.

2. It is also possible to perform various input controls with limited voice data, unlike the existing voice control methods that use tens to hundreds of voice commands.

3. It is also possible to allow a user to easily perform a voice control without learning a lot of voice commands.

4. It is also possible to provide a user interface useful for a wearable device which has difficulties in implementing and manipulating a touch screen, a virtual reality headset (VR device), and a voice controllable beam projector equipped with a mobile operating system, etc.

### BRIEF DESCRIPTION OF THE DRAWINGS

FIG. 1 is a schematic diagram of a touch screen.

FIG. 2 shows a typical home screen of an Android smartphone that is displayed through a display unit of a voice-controllable image display device according to the present invention.

FIG. 3 shows an application screen that is shown when “Apps” (ED) is touched on the home screen of FIG. 2.

FIG. 4 shows an example of an execution unit area on a screen displayed through a display unit of a voice-controllable image display device according to the present invention.

FIG. 5 shows an example of a database stored in a memory unit of a voice-controllable image display device according to the present invention.

FIG. 6 shows an example in which letters of the alphabet are assigned to execution unit areas as unique voice identification data of the execution unit areas in alphabetical order, beginning with an execution unit area at the left upper corner, when a screen displayed through a display unit of a voice-controllable image display device according to an embodiment has an execution unit area formed as a 6×4 matrix.

FIG. 7 shows an example in which voice identification data and voice control data in a voice-controllable image display device according to the present invention are used in combination.

FIG. 8 is a flowchart of a voice control method of an image display device according to the present invention.

### DETAILED DESCRIPTION

The best mode for carrying out the invention is as follows.

1. Voice-Controllable Image Display Device

A voice-controllable image display device having a display unit is configured to include a memory unit configured to store a database in which voice identification data is allocated and mapped to each execution unit area on a screen displayed through the display unit; a voice recognition unit configured to receive a user's voice as an input; an information processing unit configured to search the database and determine whether voice identification data corresponding to the user's voice is present when the voice recognition unit receives the user's voice; and a control unit configured to generate an input signal in an execution unit area to which the voice identification data is allocated when the information processing unit determines that the voice identification data corresponding to the user's voice is present.

The voice-controllable image display device is characterized in that the database additionally stores voice control data corresponding to a control command for performing a specific screen control on the basis of the execution unit area to which the voice identification data is allocated, when the voice control data is used in combination with the voice identification data; when the voice recognition unit receives a user's voice, the information processing unit searches the database and determines whether voice identification data and voice control data corresponding to the user's voice are present; and when the information processing unit determines that the voice identification data and voice control data corresponding to the user's voice are present, the control unit generates an input signal in an execution unit area to which the voice identification data is allocated and executes a control command corresponding to the voice control data on the basis of the execution unit area for which the input signal is generated.

2. Voice Control Method of Image Display Device

A voice control method for an image display device, which is performed in the voice-controllable image display device, is configured to include (a) storing a database in which voice identification data is allocated and mapped to each execution unit area on a screen displayed through the display unit, by a memory unit; (b) receiving a user's voice as an input, by a voice recognition unit; (c) searching the database and determining whether voice identification data corresponding to the user's voice is present, by an information processing unit; and (d) generating an input signal in an execution unit area to which the voice identification data is allocated when the information processing unit determines that the voice identification data corresponding to the user's voice is present, by a control unit.

Step (a) is performed by storing the database additionally including voice control data corresponding to a control command for performing a specific screen control on the basis of the execution unit area to which the voice identification data is allocated when the voice control data is used in combination with the voice identification data, by the memory unit. Step (c) is performed by searching the database and determining whether voice identification data and voice control data corresponding to the user's voice are present, by the information processing unit. Step (d) is performed by generating an input signal in an execution unit area to which the voice identification data is allocated and executing a control command corresponding to the voice control data on the basis of the execution unit area for which the input signal is generated when the information processing unit determines that the voice identification data and voice control data corresponding to the user's voice are present, by the control unit.

Hereinafter, the voice-controllable image display device and the voice control method for an image display device according to the present invention will be described in detail with reference to exemplary embodiments.

1. Voice-Controllable Image Display Device

A voice-controllable image display device according to the present invention is configured to include a display unit, a memory unit configured to store a database in which voice identification data is allocated and mapped to each execution unit area on a screen displayed through the display unit, a voice recognition unit configured to receive a user's voice as an input, an information processing unit configured to search the database and determine whether voice identification data corresponding to the user's voice is present when the voice recognition unit receives the user's voice, and a control unit configured to generate an input signal in an execution unit area to which the voice identification data is allocated when the information processing unit determines that the voice identification data corresponding to the user's voice is present. The voice-controllable image display device having such a configuration according to the present invention may include any image display device in which voice control can be implemented, such as recently released wearable devices such as smart glasses, smart watches, or virtual reality headsets (VR devices), voice-controllable beam projectors equipped with a mobile operating system, in addition to conventionally and widely used smartphones, tablet PCs, smart TVs, and navigation devices.

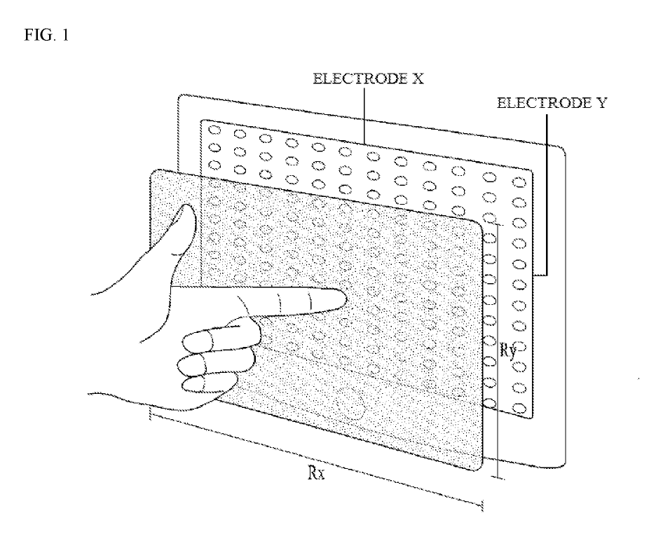

As shown in FIG. 1, an input control method of a touch screen that is applied to a smartphone, a tablet PC, etc. and widely used is classified into a pressure sensitive type and a capacitive type. The pressure sensitive type measures a coordinate value of a part of a touch screen to which pressure is applied and generates an input signal in the part. The capacitive type detects an electronic change of a touched part using sensors attached to four corners of a touch screen to measure a coordinate value and generates an input signal in the part. The touch screen type is an intuitive input method in a graphical user interface (GUI) and has very high usability. The present invention is characterized in that the merits of the touch screen type are applied to the voice control through an approach that is totally different from those of the existing voice control methods performed through a 1:1 correspondence between a voice command and a specific execution detail.

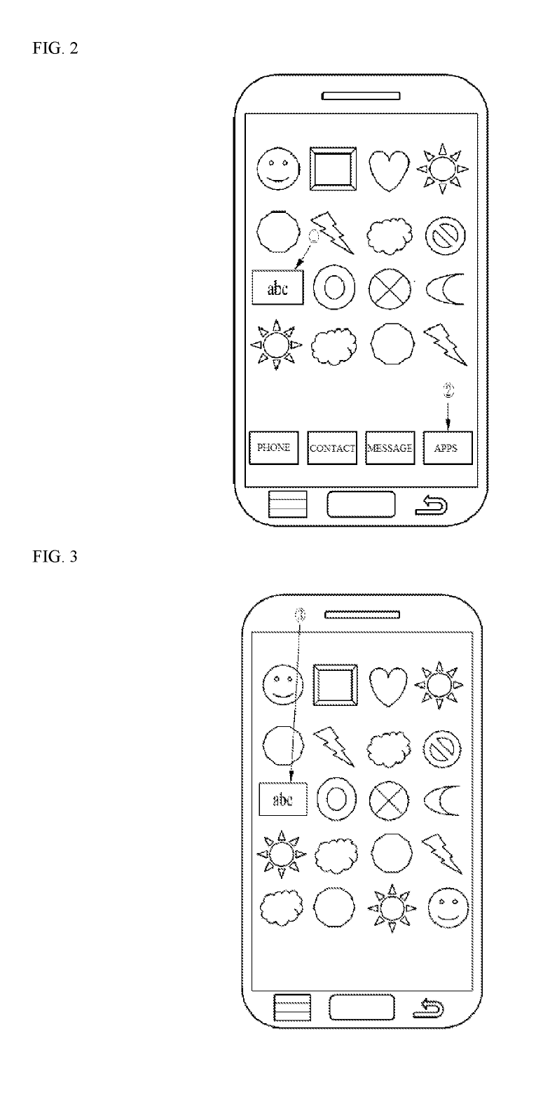

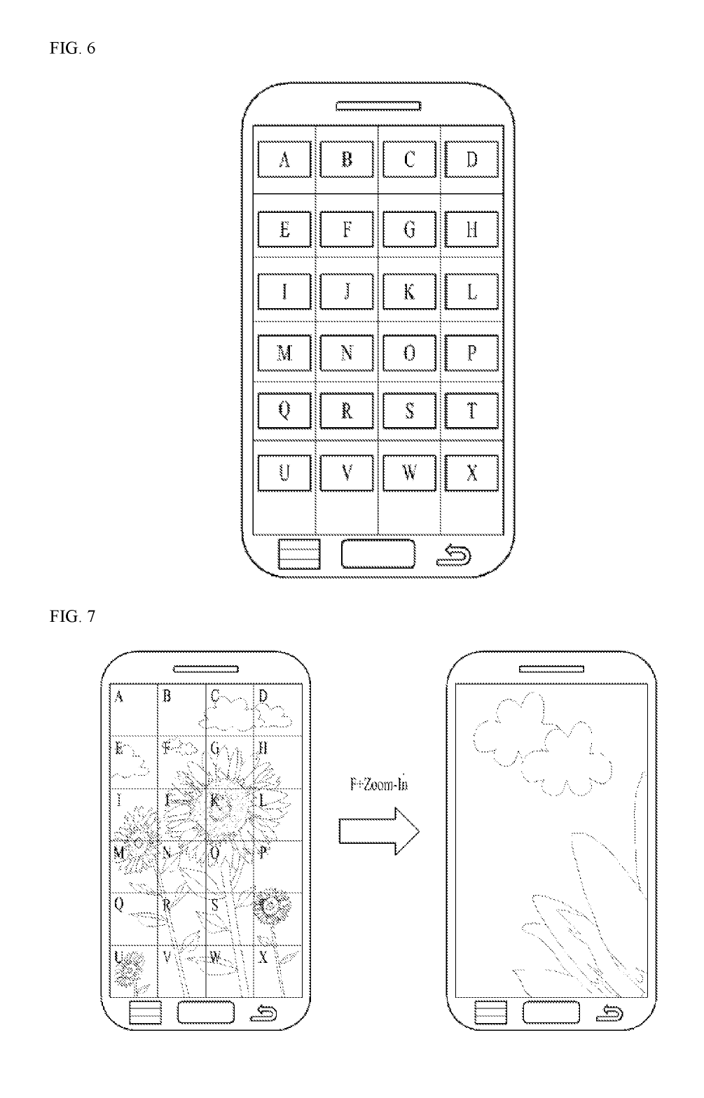

In the present invention, the execution unit area conceptually corresponds to a contact surface in which a touch screen and a touch tool (e.g., a finger, a capacitive pen, etc.) are within a contact range when a touch screen input method is performed and refers to a range in which an input signal and an execution signal are generated on a screen displayed through the display unit. That is, the execution unit area refers to a certain area composed of many pixels and conceptually may be partitioned to include one icon arrangement area, in which the same result is caused irrespective of a pixel of the area in which an input signal or an execution signal is generated, a hyperlink, etc. For example, the execution unit area is a matrix-type grid area in which shortcut icons of various applications are arranged on a screen displayed through a display unit of a smartphone as shown in as embodiment and FIGS. 2 to 6 to be described later, and is a concept with variable size, number, shape, and arrangement for each screen.

The memory unit is implemented as a memory chip built in a voice-controllable image display device that is implemented as a smartphone, a tablet PC, etc. The database is obtained by allocating and mapping voice identification data to each execution unit area on the screen displayed through the display unit. Specifically, the database includes unique coordinate information assigned to each area regarded as the same execution unit area on the screen. Also, the voice identification data may utilize data directly recorded by a user in order to improve a voice recognition rate in consideration of the user's oral structure and pronunciation characteristics. Also, the memory unit may prestore a format for each distribution pattern of an execution unit area of a default screen displayed through the display unit, thus allowing a specific format to be selected by the user.

The voice recognition unit is a part for receiving a user's voice and is implemented as a microphone device and a voice recognition circuit built in a voice-controllable image display device that is implemented as a smartphone, a tablet PC, etc.

The information processing unit and the control unit are implemented as a control circuit unit including a CPU and a RAM built in a voice-controllable image display device that is implemented as a smartphone, a tablet PC, etc. The information processing unit serves to search the database when the voice recognition unit receives a user's voice and determine whether voice identification data corresponding to the user's voice is present. In detail, when the voice identification data corresponding to the user's voice is present, the information processing unit detects unique coordinate information of an execution unit area to which the voice identification data is allocated. Also, the control unit serves to generate an input signal in the execution unit area to which the voice identification data is allocated when the information processing unit determines that the voice identification data corresponding to the user's voice is present. The control unit generates an input signal in an area on the screen having coordinate information detected by the information processing unit. The result of generating the input signal varies depending on the details of the execution unit area. When a shortcut icon of a specific application is present in the execution unit area, the application may be executed. When a specific letter of a virtual keyboard is present in the execution unit area, the letter may be input. When an instruction such as a screen transition is designated for the execution unit area, the instruction may be performed. No action may be performed in some cases.

FIG. 2 is a general home screen of an Android smartphone. FIG. 3 shows an application screen that is shown when “Apps” (\textcircled{2}) is touched on the home screen. When “abc” (\textcircled{1}) application is intended to be executed on an application screen rather than the home screen through manipulation of a touch screen, “Apps” (\textcircled{2}) is touched at the lower right corner of the home screen, and “abc” (\textcircled{3}) is touched on an application screen when the application screen is shown.

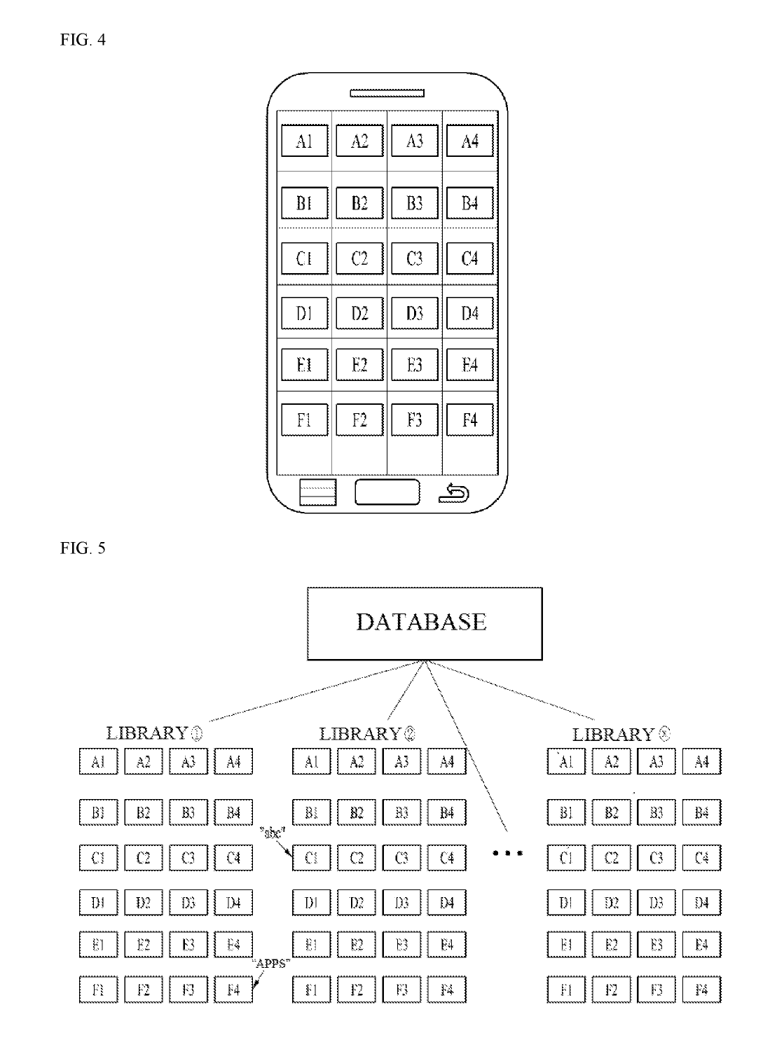

The present invention enables the above process to be implemented in a voice control method. In detail, execution unit areas of the screen displayed through the display unit are divided as shown in FIG. 4. In the database, as shown in FIG. 5, voice identification data is allocated to, mapped to, and generated in each execution unit area for each screen including a home screen and an application screen. It is assumed that voice identification data “Apps” is mapped to execution unit area F4 on the home screen displayed as library \textcircled{1} and voice identification data “abc” is mapped to execution unit area C1 on the home screen displayed as library \textcircled{2}. When the home screen is displayed in the display unit and a user's voice “Apps” is input through the voice recognition unit, the information processing unit searches the database for the home screen and determines whether voice identification data corresponding to the user's voice “Apps” are present. When the information processing unit searches for voice identification data “Apps” corresponding to the user's voice “Apps,” the control unit generates an input signal in execution unit area F4 to which the voice identification data is allocated. As a result, the application screen is executed. Also, when a user's voice “abc” is input through the voice recognition unit while an application screen is executed on the display unit, the information processing unit searches a database for the application screen and determines whether voice identification data corresponding to the user's voice “abc” is present. When the information processing unit searches for the voice identification data “abc” corresponding to the user's voice “abc,” the control unit generates an input signal in execution unit area C1 to which the voice identification data is allocated. As a result, the application “abc” is executed. As checked through the above embodiment, the database may be characterized by the voice identification data being allocated and mapped to each execution unit area on each of two different screens displayed through the display unit. Such a configuration of the database is preferable when the name of an icon displayed in an execution unit area on each screen is definite and the name of the icon is intended to be utilized as the voice identification data. When a screen has the same distribution of execution unit areas, the screen may have the same database. For example, as in the embodiments of FIGS. 2 to 5, when each screen displayed through the display unit has execution unit areas formed in a 6×4 matrix, it may be thought that alphabet letters are allocated to the execution unit areas as their unique voice identification data in alphabetical order, beginning with an execution unit area at the left upper corner of the screen. Such a configuration of the database is preferable when it is efficient to have constant voice identification data irrespective of a screen change caused by the ambiguity of the name of an icon displayed in an execution unit area for each screen, etc. In particular, when the database is configured in this method, it is preferable that the display unit be configured to show voice identification data allocated to each execution unit area on the screen when displaying the screen. In detail, a method of blurring unique voice identification data of each execution unit area as a background on the screen, etc. may be considered.

The database additionally stores voice control data corresponding to a control command for performing a specific screen control on the basis of the execution unit area to which the voice identification data is allocated, when the voice control data is used in combination with the voice identification data. When the voice recognition unit receives a user's voice, the information processing unit searches the database and determines whether there are voice identification data and voice control data corresponding to the user's voice. When the information processing unit determines that there are voice identification data and voice control data corresponding to the user's voice, the control unit generates an input signal in an execution unit area to which the voice identification data is allocated and executes a control command corresponding to the voice control data on the basis of the execution unit area for which the input signal is generated.

FIG. 7 shows a detailed embodiment in which voice identification data and voice control data are used in combination. An embodiment of FIG. 7 assumes that the screen displayed through the display unit is divided into execution unit areas formed in a 6×4 matrix, voice identification data is allocated in alphabetical order, beginning with an execution unit area at the left upper corner, and a voice control data “Zoom-In” is additionally stored as a control command for screen enlargement in the database. In this situation, when the user sequentially inputs “F” and “Zoom-In” with the user's voice, the control unit enlarges and displays execution unit area F (a part corresponding to the second row and second column) of a photograph on the screen. It will be appreciated that an input sequence of the voice identification data and the voice control data may be set to be ignored.

The voice-controllable image display device is considered as a first device, and another device that is impossible or inconvenient for a voice control is considered as a second device. Thus mirroring may also be performed. Through the mirroring, the voice control method implemented in the voice-controllable image display device may be used to control another device. A connected-car infotainment system installed in a vehicle, a smart TV, etc. may be considered as the second device.

In this case, while a control interface of the second device is displayed through the voice-controllable image display device, which is the first device, it may be difficult to identify information of the second device. For such a case, of the image signal and control information of the second device, only the text of the control information is displayed in each execution unit area on the screen displayed in the first device. The information processing unit generates text as the voice identification data through text-based voice synthesis, maps the voice identification data to each of the execution unit areas to generate a database, and shows only text of the control information on a screen displayed through the display unit, thus allowing the user to use the text of the control information shown in the display unit as a voice instruction.

Also, when the bandwidth of a wireless communication method used during wireless mirroring is not sufficiently wide or the amount of information transmitted to the second device is excessive and also information of the second device is transmitted to the voice-controllable image display device, which is the first device, only an appropriately limited amount of information may be transmitted by scaling the information of the second device.

2. Voice Control Method of Image Display Device

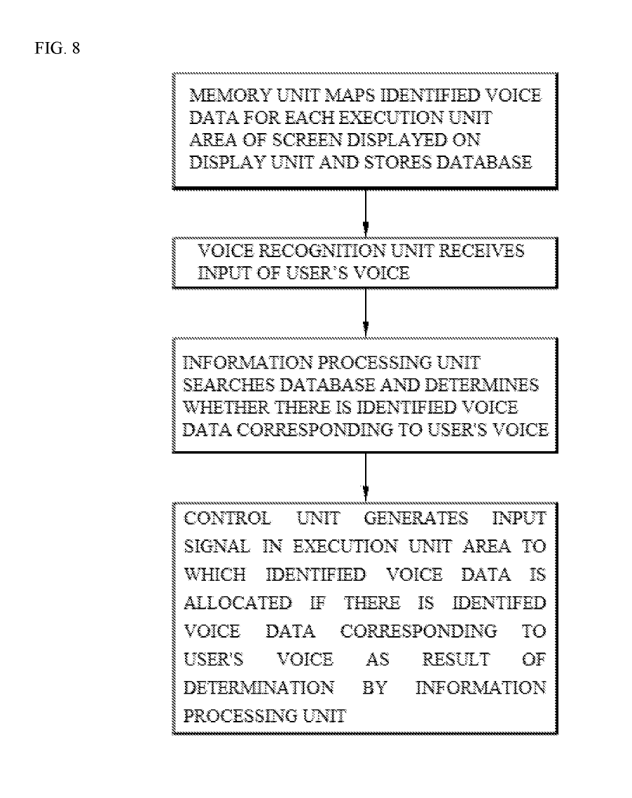

The present invention provides a voice control method of an image display device performed in the voice-controllable image display device. The voice control method is characterized as including (a) storing a database in which voice identification data is allocated and mapped to each execution unit area on a screen displayed through the display unit, by a memory unit; (b) receiving a user's voice as an input, by a voice recognition unit; (c) searching the database and determining whether voice identification data corresponding to the user's voice is present, by an information processing unit; and (d) generating an input signal in an execution unit area to which the voice identification data is allocated when the information processing unit determines that the voice identification data corresponding to the user's voice is present, by a control unit. It is assumed that the voice control method of the image display device is performed by the voice-controllable image display device according to the present invention, which has been described above. FIG. 8 is a flowchart of a voice control method of an image display device according to the present invention.

Step (a) is a step of establishing a database by a memory unit. In the database, the voice identification data is allocated and mapped to each execution unit area on a screen displayed through the display unit. In detail, the database includes unique coordinate information assigned to each area regarded as the same execution unit area on the screen. The voice identification data may utilize data directly recorded by a user in order to improve voice recognition rate in consideration of the user's oral structure and pronunciation characteristics. Also, the memory unit may prestore a format for each distribution pattern of an execution unit area of a default screen displayed through the display unit, thus allowing a specific format to be selected by the user.

Step (b) is a step of receiving a user's voice as an input by a voice recognition unit. The step is performed while the voice-controllable image display device is switched to a voice recognition mode. It is preferable that the step be performed while voice identification data allocated to each execution unit area on the screen displayed through the display unit is shown in order for the user to efficiently recognize the voice identification data.

Step (c) is a step of searching the database and determining whether voice identification data corresponding to the user's voice is present, by an information processing unit. In detail, when the voice identification data corresponding to the user's voice is present, the information processing unit detects unique coordinate information of an execution unit area to which the voice identification data is allocated.

Step (d) is a step of generating an input signal in an execution unit area to which the voice identification data is allocated when the information processing unit determines that the voice identification data corresponding to the user's voice is present, by the control unit. In the step, the control unit serves to generate an input signal in the execution unit area to which the voice identification data is allocated when the information processing unit determines that the voice identification data corresponding to the user's voice is present. The control unit generates an input signal in an area on the screen having coordinate information detected by the information processing unit. The result of generating the input signal varies depending on details of the execution unit area. When a shortcut icon of a specific application is present in the execution unit area, the application may be executed. When a specific letter of a virtual keyboard is present in the execution unit area, the letter may be input. When an instruction such as a screen transition is designated for the execution unit area, the instruction may be performed. No action may be performed in some cases.

The voice control method of the image display device according to the present invention may be characterized in that step (a) is performed by storing the database additionally including voice control data corresponding to a control command for performing a specific screen control on the basis of the execution unit area to which the voice identification data is allocated when the voice control data is used in combination with the voice identification data, by the memory unit; step (c) is performed by searching the database and determining whether voice identification data and voice control data corresponding to the user's voice are present, by the information processing unit; and step (d) is performed by generating an input signal in an execution unit area to which the voice identification data is allocated and executing a control command corresponding to the voice control data on the basis of the execution unit area for which the input signal is generated when the information processing unit determines that the voice identification data and voice control data corresponding to the user's voice are present, by the control unit. A detailed embodiment associated with this is the same as described with reference to FIG. 7.

The voice-controllable image display device and the voice control method for the image display device according to the present invention have been described above in detail with reference to exemplary embodiments. The present invention is not limited to the above detailed embodiment, and various modifications and alterations may be made without departing from the sprit of the present invention. Accordingly, the claims of the present invention include modifications and alterations falling within the spirit and scope of the present invention.

The voice-controllable image display device and the voice control method for the image display device according to the present invention are industrially applicable in that a simple and accurate voice control can be implemented by performing an input control through a comparison between a user's input voice and voice data allocated to each execution unit area on the screen displayed through the display unit and applying an input control method of the existing touch screen type without any change.

1. A voice-controllable image display device having a display unit, the voice-controllable image display device comprising:
a memory unit configured to store a database in which voice identification data is allocated and mapped to each execution unit area on a screen displayed through the display unit;
a voice recognition unit configured to receive a user's voice as an input;
an information processing unit configured to search the database and determine whether voice identification data corresponding to the user's voice is present when the voice recognition unit receives the user's voice; and
a control unit configured to generate an input signal in an execution unit area to which the voice identification data is allocated when the information processing unit determines that the voice identification data corresponding to the user's voice is present, wherein
the database additionally stores voice control data corresponding to a control command for performing a specific screen control based on the execution unit area to which the voice identification data is allocated, when the voice control data is used in combination with the voice identification data,
when the voice recognition unit receives a user's voice, the information processing unit searches the database and determines whether voice identification data and voice control data corresponding to the user's voice are present, and
when the information processing unit determines that the voice identification data and voice control data corresponding to the user's voice are present, the control unit generates an input signal in an execution unit area to which the voice identification data is allocated and executes a control command corresponding to the voice control data based on the execution unit area for which the input signal is generated.

2. The voice-controllable image display device of claim 1, wherein the display unit is configured to show voice identification data allocated to each execution unit area on the screen when displaying the screen.

3. The voice-controllable image display device of claim 1, wherein, in the database, the voice identification data is allocated and mapped to each execution unit area on more than two different screens and each of the screens displayed through the display unit.

4. (canceled)

5. A voice control method for an image display device performed in the voice-controllable image display device of claim 1, the voice control method comprising steps of:
(a) storing a database in which voice identification data is allocated and mapped to each execution unit area on a screen displayed through the display unit, by a memory unit;
(b) receiving a user's voice as an input, by a voice recognition unit;
(c) searching the database and determining whether voice identification data corresponding to the user's voice is present, by an information processing unit; and
(d) generating an input signal in an execution unit area to which the voice identification data is allocated when the information processing unit determines that the voice identification data corresponding to the user's voice is present, by a control unit, wherein
the step (a) is performed by storing the database additionally including voice control data corresponding to a control command for performing a specific screen control based on the execution unit area to which the voice identification data is allocated when the voice control data is used in combination with the voice identification data, by the memory unit,
wherein the step (c) is performed by searching the database and determining whether voice identification data and voice control data corresponding to the user's voice are present, by the information processing unit, and
wherein the step (d) is performed by generating an input signal in an execution unit area to which the voice identification data is allocated and executing a control command corresponding to the voice control data based on the execution unit area for which the input signal is generated when the information processing unit determines that the voice identification data and voice control data corresponding to the user's voice are present, by the control unit.

6. The voice control method of claim 5, wherein step (b) is performed while voice data allocated to each execution unit area on the screen displayed through the display unit is shown.

7. (canceled)
